(19) United States
(12) Patent Application Publication
(10) Pub. No.: US 2025/0270028 A1
(43) Pub. Date: Aug. 28, 2025

(54) BAG ON VALVE ASSEMBLY

(71) Applicant: Worthington Enterprises, Inc., Columbus, OH (US)

(72) Inventors: Edward Richard YOHO, Columbus, OH (US); Chase EVANS, Marysville, OH (US); Cory Blaine SHOUP, Powell, OH (US)

(21) Appl. No.: 19/206,106

(22) Filed: May 13, 2025

Related U.S. Application Data
(62) Division of application No. 18/243,530, filed on Sep. 7, 2023.
(60) Provisional application No. 63/404,219, filed on Sep. 7, 2022.

(51) Int. Cl. B65D 83/62; B65D 83/44

(52) U.S. Cl. CPC B65D 83/62; B65D 83/44

(57) ABSTRACT

Provided is a storage container that includes a body that defines an interior of the storage container, and a bag contained within the interior of the storage container. The bag is constructed of an elastomer, includes an opening, and defines a bag interior configured to contain a material. The storage container further includes a material valve assembly coupled to a portion of the body. The material valve assembly is coupled to the bag and configured to selectively provide fluid communication between the bag interior and an external environment of the storage container.

### CROSS-REFERENCE TO RELATED APPLICATIONS

This application is a divisional application of, and claims priority to U.S. Nonprovisional application Ser. No. 18/243,530, filed on Sep. 7, 2023, which claims priority to and the benefit of U.S. Provisional Application No. 63/404,219, filed on Sep. 7, 2022, the entireties of which are incorporated herein by reference.

### TECHNICAL FIELD

In general, the present invention relates to a portable storage cylinder, and in particular, to a portable storage cylinder including an inner bag that contains a material for dispensing.

### BACKGROUND OF THE INVENTION

A variety of storage containers have been used that incorporate an inner bag or bladder for containing a material. However, attachment methods of the inner bag or bladder to the surrounding storage container and/or valve can create points of failure, especially in situations where the container is dropped or is subject to a force.

### SUMMARY OF THE INVENTION

In accordance with an embodiment of the present invention, a storage container includes a body that defines an interior of the storage container, and a bag contained within the interior of the storage container. The bag is constructed of an elastomer, includes an opening, and defines a bag interior configured to contain a material. The storage container further includes a material valve assembly coupled to a portion of the body. The material valve assembly is coupled to the bag and configured to selectively provide fluid communication between the bag interior and an external environment of the storage container.

In accordance with another embodiment of the present invention, a storage container includes a body that defines an interior of the storage container, and a bag contained within the interior of the storage container. The bag defines a bag interior configured to contain a material, and the bag includes an opening and a means for preventing material blockage coupled to the bag at the opening. The storage container further includes a material valve assembly coupled to a portion of the body. The material valve assembly is coupled to the bag and configured to selectively provide fluid communication between the bag interior and an external environment of the storage container.

In accordance with another embodiment of the present invention, a storage container includes a body that defines an interior of the storage container, and a bag contained within the interior of the storage container. The bag includes an opening, and defines a bag interior configured to contain a material. The storage container further includes a material valve assembly coupled to a portion of the body. The material valve assembly is coupled to the bag and configured to selectively provide fluid communication between the bag interior and an external environment of the storage container. The storage container further includes a hose comprising a first end coupled to the material valve assembly, and a second end coupled to the opening of the bag, wherein the hose is configured to provide fluid communication between the bag interior and the material valve assembly.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a cross-sectional view of an exemplary storage container.

FIG. 2 is a view of an exemplary bag in accordance with the subject innovation.

FIG. 3 is a schematic diagram depicting the filling and dispensing of an exemplary storage container.

FIG. 4 is a cross-sectional view of an exemplary storage container.

FIG. 5 is a view of an exemplary storage container with a cutout showing an interior of the storage container.

FIG. 6 is a cross-sectional view of an exemplary storage container.

FIG. 7A is a top view of an exemplary bag.

FIG. 7B is a cross-sectional view of an exemplary bag.

FIG. 8A is a side view of an exemplary dip tube.

FIG. 8B is a cross-sectional view of an exemplary bag.

FIG. 9A is a side view of an exemplary bag.

FIG. 9B is a side view of an exemplary bag.

FIG. 10 is a side view of an exemplary spout.

FIG. 11 is a perspective view of an exemplary spout.

### DETAILED DESCRIPTION OF THE INVENTION

Embodiments of the invention include methods and systems related to a storage container having a body, a material valve, and an internal bag or bladder configured to contain a material. The bag or bladder can be coupled to the material valve within the storage container by way of a hose, or in certain embodiments, the bag or bladder can directly couple to the material valve. The storage container can include a chamber configured to internally store a compressed gas, such as air, in a space between the bag/bladder and the body. A user can dispense the material out of the bag or bladder, through the hose and material valve (or directly through the material valve in embodiments without a hose), into an exterior environment. The compressed gas can act as a propellant in dispensing the material to the exterior environment.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

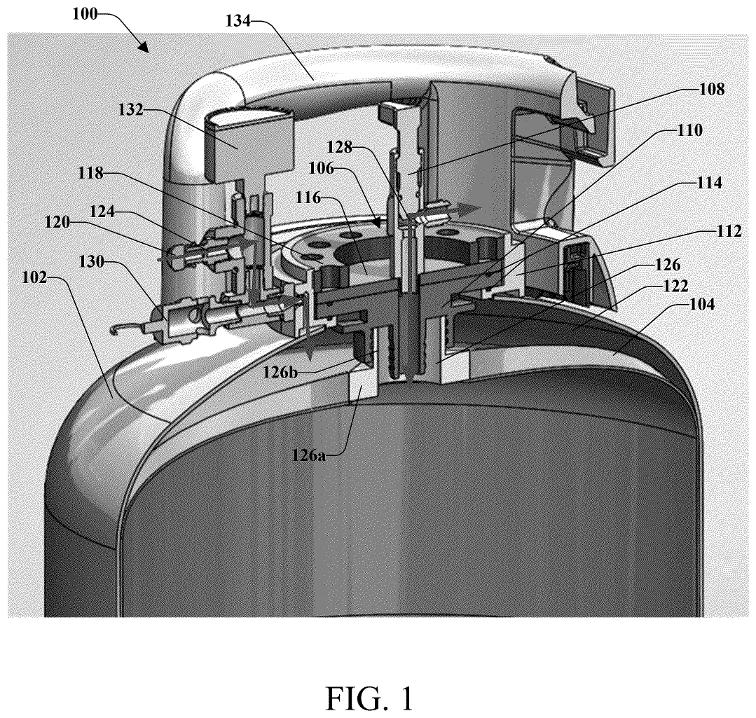

Turning now to FIG. 1, a storage container 100 is shown. The storage container 100 can include a top, a bottom opposite the top, and a cylindrical sidewall connecting the top and bottom, where the cylindrical sidewall has a length. The storage container 100 includes a body 102 that can be constructed of or fabricated with any material chosen using sound engineering judgment. By way of example, and not limitation, the body 102 can be constructed using one or more of metal, such as steel or aluminum, carbon fiber, glass fiber, a plastic, a composite material such as metal combined with plastic, or a polymer such as high density polyethylene. The body 102 defines an interior space within the storage container 100. Located within the interior space of the storage container is a bag 104. It should be appreciated that the term bag as used herein can mean a bag, a bladder, or any other enclosed structure capable of containing a fluid. The bag 104 can be constructed of a single layer or multiple layers of one or more of a plastic, a foil, a metalized material, a non-metalized material, polyurethane, an elastomer such as thermoplastic polyurethane (TPU), ethylene-vinyl acetate (EVA), or flexible polyvinyl chloride (PVC), among others. The bag 104 can have an opening on one end. The storage container 100 can further include a material valve assembly 106 that includes a manually actuated valve 108, and a spout adapter 110. In certain embodiments, the material valve assembly 106 can be coupled with the top of the storage container 100. The material valve assembly 106 can also include a spud 112 that can be ring-shaped and that forms an opening while also connecting the material valve assembly 106 to the body 102, one or more O-rings 114, a valve plate 116, and a pressure ring 118. It should be appreciated that instead of, or in addition to, O-rings 114, gaskets and/or adhesives or pastes, putties, epoxies, or sealants such as Loctite® or PTFE tapes or other material sealant tapes may be used, each of which may be used on threads of the material valve assembly 106 or not on the threads of the material valve assembly 106. The storage container 100 can also include a charge gas valve 120 fluidly connected to a chamber 122 within the body 102, located between the bag 104 and the body 102. The bag 104 can be hermetically sealed with respect to the chamber 122. The charge gas valve 120 is connected to the chamber 122 via a charge gas path 124 that is configured to provide fluid communication between a pressurized gas source and the chamber 122. In certain embodiments, the storage container 100 can also include a hand pump in place of, or in addition to, the charge gas valve 120. In an example, a user can utilize the hand pump to manually pressurize the chamber 122 with air or another gas. It should be appreciated that the material valve assembly 106 can be physically coupled to the body 102 to create an air-tight or gas-tight seal within the chamber 122.

In certain embodiments, the bag 104 can be directly coupled to the valve assembly 106 by a spout 126 or another connection method such as a weld, barbs, quick connect fittings, a washer fitting, among others. For example, a first end 126a of the spout 126 can be coupled to the bag 104 and a second end 126b of the spout 126 can be coupled to the material valve assembly 106. The first end 126a of the spout 126 can be coupled to the bag 104 using, for example, an adhesive or a weld, depending on the material. In one example, the first end 126a of the spout 126 can be coupled to the opening of the bag 104. The second end 126b of the spout 126 can be coupled to the material valve assembly 106, for example, by being coupled to the spout adapter 110. In one embodiment, the spout adapter 110 can include a threaded connection that extends into the interior of the body 102. The second end 126b of the spout 126 can include a corresponding threaded connection that mates with the threaded connection of the spout adapter 110. In these embodiments, the bag 104 hangs directly from the material valve assembly 106 within the body 102. The bag 104 can be made of a material selected such that the bag 104 is stretchable (e.g. thermoplastic polyurethane (TPU), ethylene vinyl acetate (EVA), or flexible polyvinyl chloride (PVC)). For example, in certain embodiments, the bag 104 can be stretchable between 500% and 800% of its unstretched length. In other embodiments, the bag 104 can be stretchable between 200% and 1,000% of its unstretched length. The stretchable nature of the bag 104 protects the bag from damage during an impact or a drop. When an impact is made on the body 102, the force provided by the contents of the bag 104 causes the bag 104 to temporarily expand to relieve the force.

The connection of the spout 126 to the material valve assembly 106 creates a material flow path 128 between an interior of the bag 104 and the external environment. It should be appreciated that material can flow through the material flow path 128 in either direction. For example, a user can fill the bag with a material such that the material flows inward from the manually actuated valve 108, through the material flow path 128 and into the interior of the bag 104. The user can also dispense material such that the material flows from the interior of the bag 104, through the material flow path 128, and out of the manually actuated valve 108 into the external environment. The material can be any type of fluid such as a liquid, a gas, or a granulized solid suspended in a liquid. In certain embodiments, the material can be an adhesive, a foam, a paint, or a liquid food or drink product. In certain embodiments, the material can also include a refrigerant. When a refrigerant is mixed with another fluid in the bag 104, the refrigerant can act as a blowing agent or as a propellent from within the bag 104. When the refrigerant acts as a propellant, the bag 104 stretches outward and maintains contact with the interior walls of the body 102 and no air charge is necessary within the chamber 122. When the refrigerant is a blowing agent, its vapor pressure is less than an air charge pressure that exists within the chamber 122.

In certain embodiments, the storage container 100 can further include additional components such as a pressure relief device 130 and/or a pressure gauge 132. In certain embodiments, the pressure relief device 130 and/or the pressure gauge can be connected to the charge gas path 124. The pressure gauge 132 can measure and display the pressure of a gas within the chamber 122. In one embodiment, the pressure relief device 130 can be a blowout valve that can be configured to vent the gas from the chamber 122 to the external environment when the pressure of the gas within the chamber 122 exceeds a predetermined threshold. In another embodiment, the pressure relief device 130 can be a blow out disk coupled to the body 102. The blow out disk can be configured to rupture to vent gas from the chamber 122 to the external environment when the pressure of the gas within the chamber 122 exceeds a predetermined threshold. In certain embodiments, a second pressure relief device can be included on the material valve assembly 106, which is configured to vent liquid from the bag 104 to the exterior atmosphere in situations where the bag's 104 internal pressure exceeds a predetermined threshold pressure. Further, the storage container 100 can include one or more handles 134 configured to allow a user to grip and carry the storage container 100. The one or more handles 134 also provide protection to the material valve assembly 106 in the event that the storage container 100 is dropped.

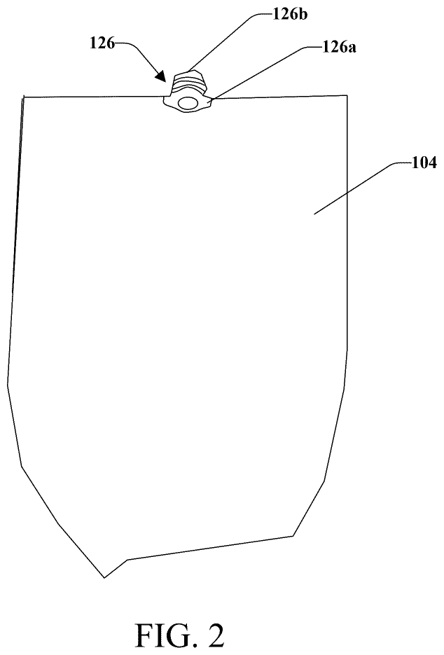

Turning now to FIG. 2, an exemplary bag 104 is shown. The bag 104 includes a spout 126 having a first end 126a welded to a top portion of the bag 104. The first end 126a includes an expanded surface that provides a contact surface for welding to the bag 104 material. The spout 126 also includes a second end 126b that is threaded for connection to the spout adapter 110 of the material valve assembly 106.

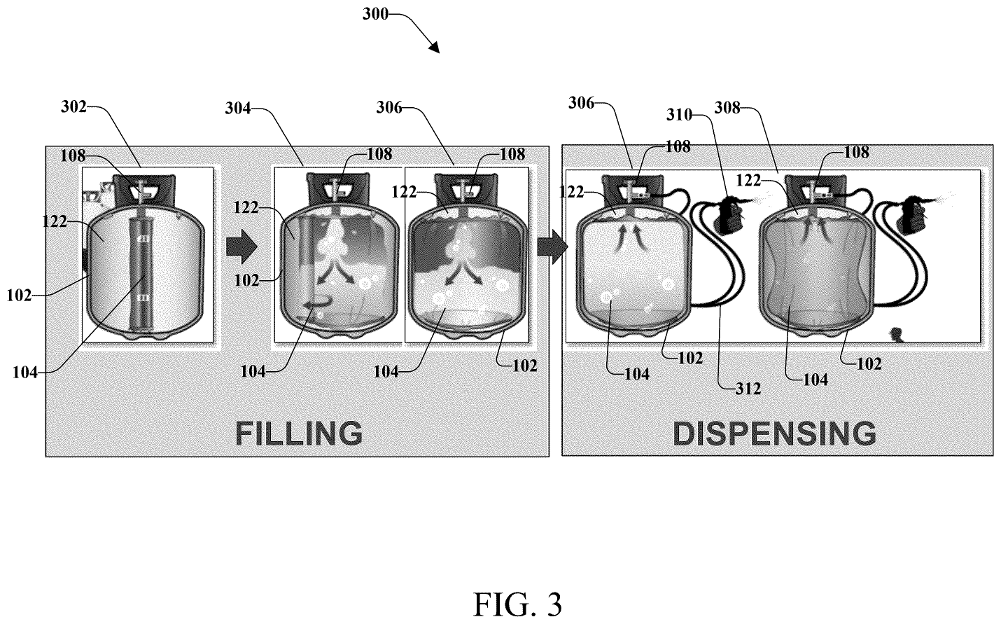

FIG. 3 is a schematic diagram 300 representing an exemplary storage container 100 during a filling process and a dispensing process. At numeral 302, a storage container 100 is provided. The bag 104 is inserted into an interior of the body 102. A user can pressurize the chamber 122 by applying a pressurized gas to the charge gas valve 120. The pressurized gas can be, for example, pressurized air or a propellant gas. It should be appreciated that the chamber 122 can be pressurized either before or after filling the bag 104 with the material is shown at numeral 304. Turning now to numeral 304, a user can fill the bag 104 with the material by providing the material to the manually actuated valve 108. The material can flow from the manually actuated valve 108, through the material flow path 128, and into the bag 104. While the bag 104 is being filled with the material, the bag 104 begins to expand in volume within the body 102. The expansion of the bag 104 within the body 102 causes the volume of the chamber 122 to decrease as shown at numerals 306 and 308. When the filling process is completed, the storage container 100 contains the material within the bag 104 and a pressurized gas within the chamber 122.

A dispensing process is depicted starting at numeral 306. In certain embodiments, a dispensing device 310 can be coupled to the manually actuated valve 308 by way of tubing 312. For example, the dispensing device 310 can be an adhesive applicator, a tap, a faucet, or a paint sprayer, among others. The manually actuated valve 108 can be actuated to dispense the material via the dispensing device 310. When the manually actuated valve 108 is actuated to dispense the material, the pressurized gas within the chamber 122 applies a force on the outside of the bag 104 and causes the material to be expelled from the bag 104, thus forcing the material to flow through the flow path 128. As the material is dispensed from the manually actuated valve 108, the material flows from the bag 104, through the material flow path 128, and out the manually actuated valve 108. In embodiments that utilize a dispensing device 310, the material also flows out of the manually actuated valve 108, through the tubing 312, and out through the dispensing device 310. As the material is being dispensed from the bag 104, the volume taken up by the bag 104 decreases within the body 102, which increases the volume of the chamber 122 as depicted at numeral 308.

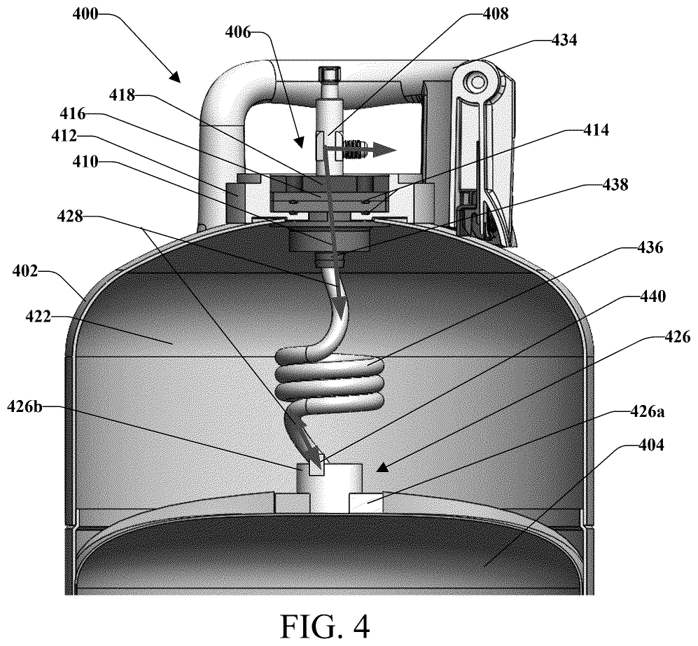

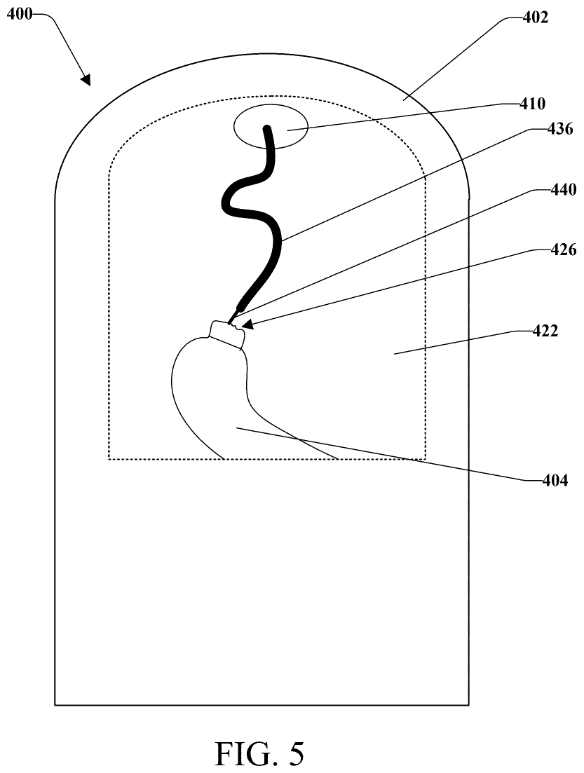

Turning now to FIGS. 4 and 5, an embodiment of a storage container 400 is shown. Similar to storage container 100, storage container 400 includes a body 402 that can be constructed of any material chosen using sound engineering judgment. By way of example, and not limitation, the body 402 can be constructed using one or more of metal, such as steel or aluminum, carbon fiber, glass fiber, or a polymer such as high density polyethylene. The body 402 defines an interior space of the storage container 400. Located within the interior space of the storage container is a bag 404. The bag 404 can be constructed of a single layer or multiple layers of one or more of a plastic, a foil, a metalized material, a non-metalized material, or an elastomer such as thermoplastic polyurethane (TPU), ethylene vinyl acetate (EVA), flexible polyvinyl chloride (PVC), among others. The bag 404 can include an opening on one end. The storage container 400 can further include a material valve assembly 406 that includes a manually actuated valve 408, and a spout adapter 410. The material valve assembly 106 can also include a spud 412, one or more O-rings 414, a valve plate 416, and a pressure ring 418. In certain embodiments, the valve plate 416 and the spout adapter 410 can be combined to exist as a single spout adapter 410 component. Although not shown in FIG. 4, the storage container 400 can also include a charge gas valve fluidly connected to a chamber 422 within the body 402, located between the bag 404 and the body 402. The charge gas valve can be connected to the chamber 422 via a charge gas path. The charge gas valve and charge gas path can be arranged on and function with storage container 400 in the same manner as the charge gas valve 120 and charge gas path 124 on storage container 100. In certain embodiments, the storage container 400 can also include a hand pump in place of, or in addition to, the charge gas valve. A user can utilize the hand pump to manually pressurize the chamber 422 with air. It should be appreciated that the material valve assembly 406 can be physically coupled to the body 402 to create an air-tight or gas-tight seal within the chamber 122.

In certain embodiments, the bag 404 can be fluidly coupled to the valve assembly 406 by way of a hose 436. The hose 436 can include a first end coupled to the material valve assembly 406 and a second end coupled to the bag 404 by a spout 426. For example, a first end 426a of the spout 426 can be coupled to the bag 404 using, for example, an adhesive or a weld, and a second end 426b of the spout 426 can be coupled to the second end of the hose 436. In an example, the first end 426a of the spout 426 can be coupled to the opening of the bag 404. The hose 436 is configured to provide a dampening effect to prevent physical damage to the bag 404, the spout 426, or the material valve assembly 406 in the event that a force is applied to the bag 404 due to the storage container 400 being dropped or the storage container 400 receiving a force due to an impact.

The hose 436 provides fluid communication between the interior of the bag 404 and the material valve assembly 406. The hose 436 can be constructed of a flexible material such as a plastic, a rubber, or an elastomer such as thermoplastic polyurethane (TPU), ethylene-vinyl acetate (EVA), flexible polyvinyl chloride (PVC), nylon (PA), polypropylene (PP), polyethylene (PE), or a braided construction. In certain embodiments, the hose 436 can have a length that allows for the hose to expand and/or stretch within the interior of the body 402 without detaching from the material valve assembly 406 or the bag 404. The hose 436 can be coiled between the first end and the second end, or it can be straight. In one example, the hose 436 is coiled between the first end and the second end of the hose 436. In one example, the hose 436 can expand at the coiled portion of the hose 436 and provide a dampening effect when a downward force is exerted on the bag 404 within the body 402. In another example, the hose 436 can be constructed from a flexible and/or stretchable material such that the hose 436 can stretch to provide a dampening effect when a downward force is exerted on the bag 404 within the body 402. It should be appreciated that in certain embodiments, the hose 436 can be both coiled and constructed from a flexible and/or stretchable material to provide a dampening force by way of the coiled portion of the hose 436 and also the flexing and/or stretching of the hose 436 material.

As shown in FIGS. 4 and 5, the material valve assembly 406 can include a first fitting 438 configured to couple the material valve assembly 406 to the first end of the hose 436. In one embodiment, the first fitting 438 is part of the spout adapter 410. In certain embodiments, the first fitting 438 can be any of a barbed fitting, a compression fitting, a ferrule fitting, a threaded fitting, a clamp fitting, a push-to-connect fitting, a quick-connect fitting, among others. The spout 426 can include a second fitting 440 configured to couple the bag 404 to the second end of the hose 436. In one embodiment, the second fitting 440 is part of the spout 426. In certain embodiments, the second fitting 440 can be any of a barbed fitting, a compression fitting, a ferrule fitting, a threaded fitting, a clamp fitting, a push-to-connect fitting, a quick-connect fitting, among others.

The hose 436 creates a material flow path 428 between an interior of the bag 404 and the external environment. It should be appreciated that material can flow through the material flow path 428 in either direction. For example, a user can fill the bag with a material such that the material flows inward from the manually actuated valve 408, through the material flow path 428 and into the interior of the bag 404. The user can also dispense material such that the material flows from the interior of the bag 404, through the material flow path 128, and out of the manually actuated valve 408 into the external environment. The material can be any type of fluid such as a liquid or a gas. In certain embodiments, the material can be an adhesive, a foam, a paint, or a liquid food or drink product. In certain embodiments, the material can also include a refrigerant. When a refrigerant is mixed with another fluid in the bag 404, the refrigerant can act as a blowing agent or as a propellent from within the bag 404. When the refrigerant acts as a propellant, the bag 404 stretches outward and maintains contact with the interior walls of the body 402 and no air charge is necessary within the chamber 422. When the refrigerant is a blowing agent, its vapor pressure is less than an air charge pressure that exists within the chamber 422. It should be appreciated that the storage container 400 can function as part of the processes 300 depicted in FIG. 3 with respect to the storage container 100.

In certain embodiments, multiple bags 404 can be included within the body 402. Each of the multiple bags 404 can have a corresponding hose 436 that couple with a corresponding fitting on the valve assembly 406. In these embodiments, the contents of each individual bag can be dispensed individually through the valve assembly 406 or dispensed simultaneously to mix the contents through the valve assembly 406, depending on the necessary application.

Although not shown in FIG. 4, the storage container 400 can further include additional components such as a pressure relief device and/or a pressure gauge. The pressure gauge can measure and display the pressure of a gas within the chamber. The pressure relief device (e.g. blowout valve or blowout disk) can be configured to vent the gas from the chamber 422 to the external environment when the pressure of the gas within the chamber 422 exceeds a predetermined threshold. Further, the storage container 400 can include one or more handles 434 configured to allow a user to grip and carry the storage container 400.

In certain embodiments, the storage container 400 can further include a compressible material located in between the bag 404 and the body 402. The compressible material can provide further cushioning to the bag 404 when a force is applied to the storage container 400. The compressible material can be constructed of, for example, a rubber or a foam material. In certain embodiments, the compressible material can be attached to the interior of the body 402 or attached to the bag 404. In other embodiments, the compressible material is not attached to the interior of the body 402, and is rather free moving within the chamber 422. The compressible material lessens the force applied to the bag 404 from a collision of the bag 404 with the body 402.

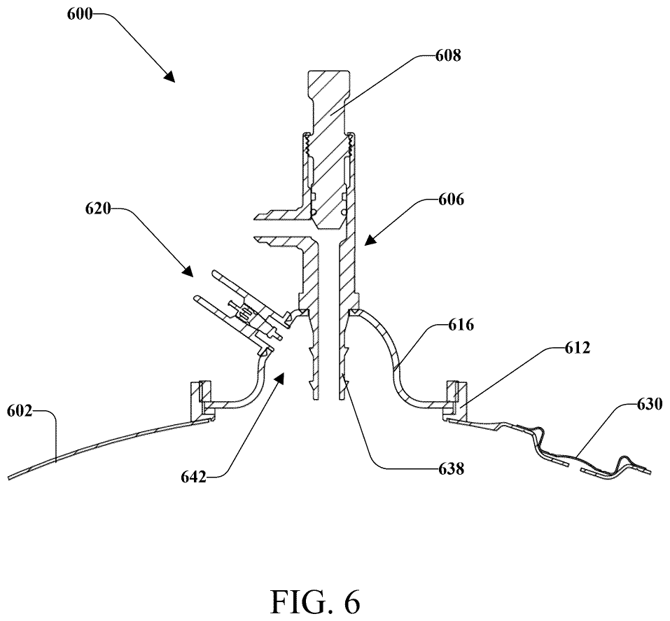

Turning now to FIG. 6, a cross-sectional view of another embodiment of a storage container 600 is shown. It should be appreciated that storage container 600 can include many of the same or similar components and features as disclosed with regards to storage container 100 and storage container 400. Storage container 600 contains a body 602 and a material valve assembly 606 coupled thereto. The body 602 can also include a pressure relief device 630 such as a burst disc or a pressure relief valve, in communication with the chamber. The material valve assembly 606 can include, for example, a manually actuated valve 608 that can be operated by a user to dispense a contents of the storage container 600. It should be appreciated that a second pressure relief device may also be included on the material valve assembly 606, configured to vent or relieve pressure from the inside of the bag within the body 602 to the outside atmosphere. It should be appreciated that the storage container 600 can function as part of the processes 300 depicted in FIG. 3 with respect to the storage container 100.

The storage container 600 can further include a concave pocket 642 in which the valve assembly 606 is inserted. A first fitting 638 of the valve assembly 606 extends through an aperture in the concave pocket 642 and into the space created by the concave pocket 642. The first fitting 638 provides a connection point for either a first end of a hose or a bag that is connected directly to the first fitting 638. The concave pocket 642 provides a protective space for the first fitting 638 such that the first fitting 638 only extends to a position located above a plane that would extend across the top surface of the body 602. The location of the first fitting 638 within the concave pocket 642 protects the first fitting 638 from being damaged by a bag contained within the storage container 600 in the event the storage container 600 falls upside down.

In another embodiment, first fitting 638 can be an angled fitting. The first fitting 638 can extend downwards into the interior of the body 602, bend at an angle (e.g. 90 degrees), and include a hose connection point extending at an angle to the downward extending portion of the first fitting 638. The bend can include a rounded exterior to ensure that the first fitting 638 does not puncture or damage the bag 604 should the bag 604 come into contact with the first fitting 638.

As shown in FIG. 6, the concave pocket 642 can be formed as part of a valve plate 616 that is coupled to the body 602 by, for example, a spud 612. In other embodiments, the concave pocket 642 can be formed as part of the body 602. A charge gas valve 620 can also be coupled to the storage container 600. In one embodiment as shown in FIG. 6, a charge gas valve 620 can be coupled at the concave pocket 642. In another embodiment, the charge gas valve 620 can be coupled at the valve assembly 606. In still another embodiment, the charge gas valve 620 can be coupled at the body 602. In various other embodiments of the storage container 600, a piercing member (not shown) can also extend from either an inner top surface of the body 602 or from the concave pocket 642 and extend into the chamber formed by the body 602. The piercing member is configured to puncture a bag when the bag is emptied of its contents and suctioned up towards the valve assembly 606 as a way of rendering the bag inoperable for re-use to ensure that the bag is discarded by the user.

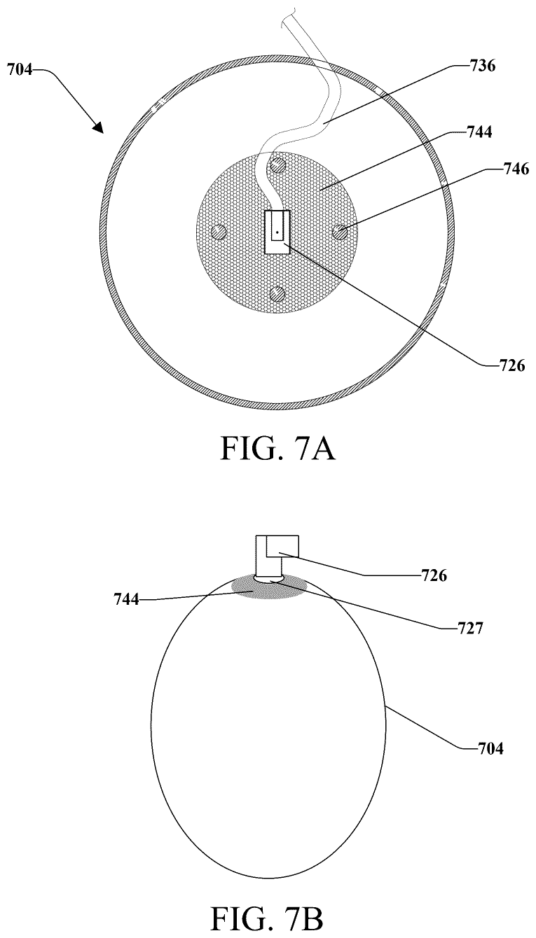

Turning now to FIGS. 7A and 7B, an exemplary bag 704 is shown. FIG. 7A depicts a top view of the bag 704 and FIG. 7B depicts a cross-sectional view of the bag 704. An open celled foam 744 may be utilized in order to prevent a portion of the bag 704 from sealing or impeding the flow of material to the spout 726 during emptying of the bag 704 through the spout 726 and any connected valve. The open celled foam 744 can be coupled to an inside top portion of the bag 704, covering the opening 727 of the bag 704 that leads to the spout 726. The open celled foam 744 can be adhered or welded to the inside of the bag 704 at one or more connection points 746. In one embodiment, the connection points 746 can be positioned at two or more locations. In another embodiment, the connection point 746 may be one or more non-continuous lines.

The open celled foam 744 can be constructed of any suitable material, having pores that allow a fluid contents of the bag 704 to flow through the open celled foam 744. In certain embodiments, the s open celled foam 744 can be constructed of the same material as the bag 704. Fluid material from inside the bag 704 can flow from within the bag 704, through the open celled foam 744, and out through an opening 727 in the bag 704 through a spout 726, through the hose 736, and out of the corresponding storage container (e.g. 100, 400, 600) via a valve assembly (e.g. 106, 406, 606). As the fluid contents is being emptied from the bag 704, the bottom and/or sides of the bag 704 are drawn towards the opening 727 of the bag 704. The bottom and/or sides of the bag 704 contact the open celled foam 744, which prevents the bag 704 from self-scaling and trapping remaining fluid material within the bag 704. While the bottom and/or sides of the bag 704 contact the open celled foam 744, fluid material remaining within the bag 704 can still flow through portions of the open celled foam 744 and out of the bag 704. It should be appreciated that the open celled foam 744 can have any shape chosen using sound engineering judgment. In one embodiment, the open celled foam 744 is disc-shaped. The open celled foam 744 has a thickness such that when a portion of the bag 704 contacts a bottom surface of the open celled foam 744, fluid material may still flow through the sides of the open celled foam 744.

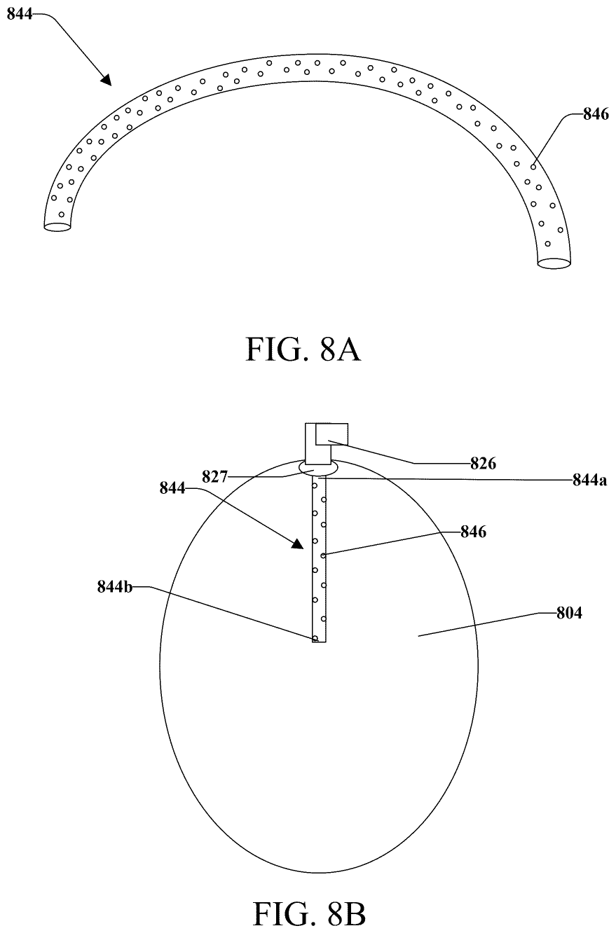

FIG. 8A and 8B depict an embodiment that incorporates a dip tube 844 extending into the bag 804. The dip tube 844 can include a plurality of holes 846 located around a circumference of the dip tube 844 and along the length of the dip tube 844. A first end 844a of the dip tube 844 can be coupled with the spout 826. A second end 844b of the dip tube 844 can extend a portion of the depth of the bag 804. In certain embodiments, the second end 844b of the dip tube can be open, and in others, the second end 844b can be closed. As the fluid contents of the bag 804 is dispensed and the bag 804 collapses inwards and/or upwards on itself, the dip tube 844 prevents the bag 804 from self-scaling the opening 827 of the bag 804 and impeding the flow of material to the material valve and trapping remaining fluid material within the bag 804. It should be appreciated that the dip tube 844 can be any shape including cylindrical tube, U-shaped, zig-zag, I-shaped, rectangular-shaped, coiled, among others. The dip tube 844 can be flexible or it can be rigid.

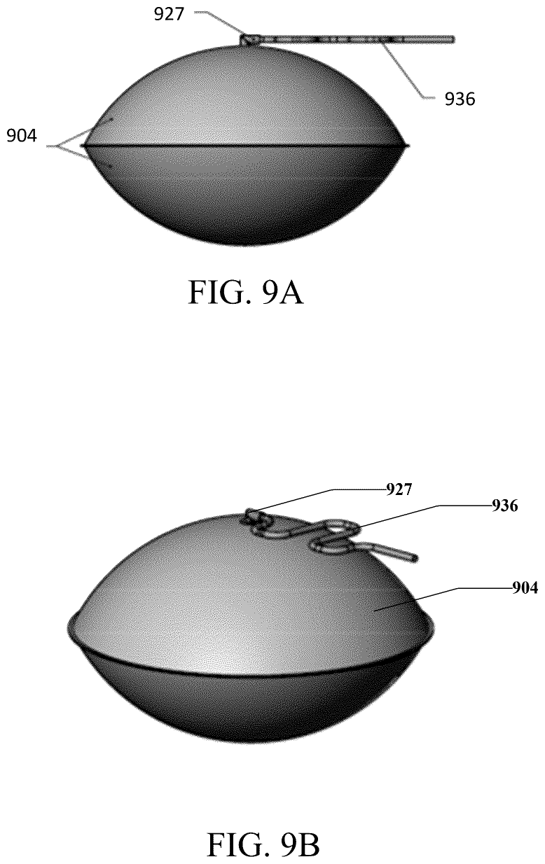

Turning now to FIG. 9A, an embodiment of a bag 904 is shown. The bag 904 can have a spout 927 that couples the bag 904 to the hose 936. In certain embodiments, the bag 904 can be constructed of two halves joined together by, for example, a weld. As shown in FIG. 9A, the hose 936 can be straight. In the embodiment of FIG. 9B, the hose 936 can be bent or coiled.

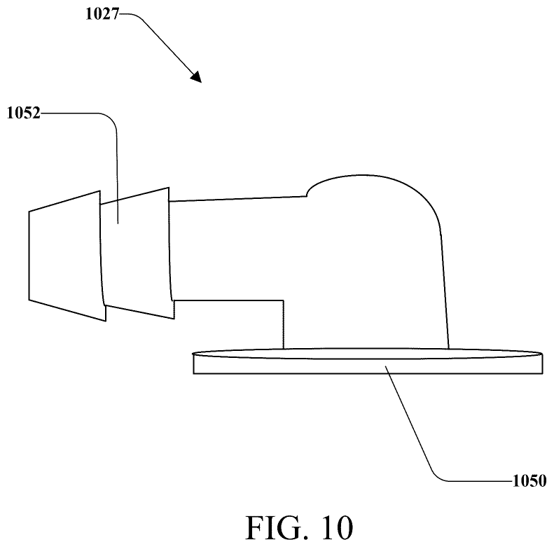

FIG. 10 depicts an exemplary spout 1027. The spout 1027 can include a flange portion 1050 configured to be coupled to the opening (e.g. 727, 827) of a bag (e.g. 704, 804). For example, the flange portion 1050 can be adhered or welded to the corresponding opening of the bag. The spout 1027 can also include a tube coupling portion 1052 configured to receive the hose 936. The tube coupling portion 1052 can be, for example, a barb, a friction fit, a clamp, or a quick-connect, among others. In other embodiments, the hose 936 is welded directly to the tube coupling portion 1052.

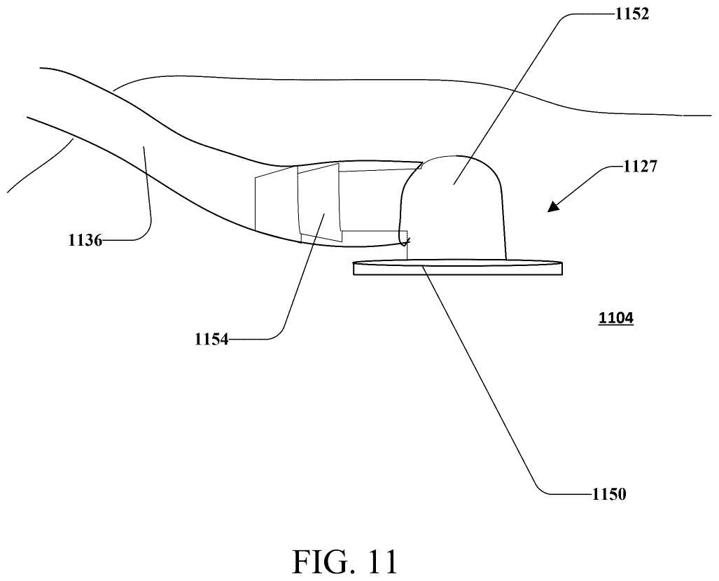

FIG. 11 depicts another exemplary spout 1127. The spout 1127 can include a mounting portion 1150 that can be coupled to an exterior surface of the bag 1104. The mounting portion 1150 can be coupled to the bag 1104 by way of an adhesive or a weld, among other methods of joining the components. The spout 1127 can also include a receptacle portion 1152 molded or coupled to the mounting portion 1150. The spout 1127 can be constructed of a flexible material, and may be made of the same material as the bag 1104 such that the spout 1127 is able to flex and bend with the bag 1104. For example, the spout 1127 can be made of thermoplastic polyurethane (TPU), ethylene vinyl acetate (EVA), or flexible polyvinyl chloride (PVC). The receptacle portion 1152 is configured to receive an insert 1154. The insert 1154 is a rigid or semi-rigid component that has a first end inserted into the receptacle portion 1152 and a second end inserted into the hose 1136. The first end and second end of the insert can be a barb, a friction fit, a clamp connector, or a quick connect, among others. The insert can also be direct welded to other components such as the spout 1127 and/or the hose 1136.

The aforementioned systems, components, (e.g., body, bag, material valve assembly), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

While the embodiments discussed herein have been related to the systems and methods discussed above, these embodiments are intended to be exemplary and are not intended to limit the applicability of these embodiments to only those discussions set forth herein.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A storage container comprising:
a body that defines an interior of the storage container;
a bag contained within the interior of the storage container, wherein the bag is constructed of an elastomer, includes an opening, and defines a bag interior configured to contain a material;
a material valve assembly coupled to a portion of the body, wherein the material valve assembly is coupled to the bag and configured to selectively provide fluid communication between the bag interior and an external environment of the storage container, and wherein the storage container further comprises at least one of:
an open celled foam coupled with an inner surface of the bag, wherein the open celled foam covers the opening of the bag, or
a dip tube extending from the opening of the bag into the bag interior.

2. The storage container of claim 1, wherein the open celled foam is constructed from the same material as the bag.

3. The storage container of claim 1, wherein the open celled foam is configured to permit a flow of the material from the bag interior through the material valve assembly.

4. The storage container of claim 1, wherein the dip tube comprises a plurality of holes along a length of the dip tube.

5. The storage container of claim 1, wherein the dip tube is cylindrical, U-shaped, I-shaped, zig-zagged, rectangular-shaped, or coiled.

6. The storage container of claim 1, wherein the dip tube is flexible.

7. A storage container comprising:
a body that defines an interior of the storage container;
a bag contained within the interior of the storage container, wherein the bag defines a bag interior configured to contain a material, and wherein the bag includes an opening and a means for preventing material blockage coupled to the bag at the opening; and
a material valve assembly coupled to a portion of the body, wherein the material valve assembly is coupled to the bag and configured to selectively provide fluid communication between the bag interior and an external environment of the storage container.

8. The storage container of claim 7, wherein the means for preventing material blockage is an open celled foam.

9. The storage container of claim 8, wherein the open celled foam is constructed from the same material as the bag.

10. The storage container of claim 8, wherein the open celled foam covers the opening of the bag.

11. The storage container of claim 8, wherein the open celled foam is configured to permit a flow of the material from the bag interior through the material valve assembly.

12. The storage container of claim 7, wherein the means for preventing material blockage is a dip tube extending from the opening of the bag into the interior of the storage container.

13. The storage container of claim 12, wherein the dip tube includes a plurality of holes along a length of the dip tube.

14. The storage container of claim 12, wherein the dip tube is cylindrical, U-shaped, I-shaped, zig-zagged, rectangular-shaped, or coiled.

15. The storage container of claim 12, wherein the dip tube is flexible.
